(19) United States
(12) Patent Application Publication
(10) Pub. No.: US 2023/0313929 A1
(43) Pub. Date: Oct. 5, 2023

(54) CONNECTION DEVICE BETWEEN A PIPE AND A BASE

(71) Applicant: A. RAYMOND ET CIE, Grenoble (FR)

(72) Inventors: Jérôme Chaupin, Bret en Belledonne (FR); Frédéric Poggi, Fontaine (FR)

(21) Appl. No.: 18/044,161

(22) PCT Filed: Aug. 10, 2021
(86) PCT No.: PCT/EP2021/072298

§ 371 Date: Mar. 6, 2023

(30) Foreign Application Priority Data
Sep. 9, 2020 (FR) FR2009125

(51) Int. Cl. F16L 37/098; F16L 43/02

(52) U.S. Cl. CPC F16L 37/0982; F16L 43/02; F16L 2201/10

(57) ABSTRACT

A connection device for connecting at least one pipe and a base and topped by a collar comprises a connection end piece for fluidly connecting the pipe to the base and a retaining ring for keeping the connection end piece assembled with the base. The connection end piece comprises a tubular body and at least one first retaining element. The retaining ring comprises an annular body provided with a second retaining element engaging with the first retaining element to retain the retaining ring on the connection end piece. The retaining ring also comprises at least one locking tab integral with the annular body in order to grip the collar and keep the retaining ring assembled with the base.

### CROSS-REFERENCE TO RELATED APPLICATIONS

This application is a national phase entry under 35 U.S.C. § 371 of International Patent Application PCT/EP2021/072298, filed Aug. 10, 2021, designating the United States of America and published as International Patent Publication WO 2022/053246 A1 on Mar. 17, 2022, which claims the benefit under Article 8 of the Patent Cooperation Treaty to French Patent Application Serial No. FR2009125, filed Sep. 9, 2020.

### TECHNICAL FIELD

The present disclosure relates to a connection device between a pipe and a base having a tubular segment provided with a collar. This type of device is of particular interest in the automotive field, and more specifically for the connection of fluid pipes.

### BACKGROUND

Documents EP2759757, US2008048447, EP1781979, WO2019096596, EP0579194, US20180238479 disclose such connection devices. A lock, generally C-shaped, is clipped around a connection element to keep it attached to the base. These devices can have the drawback of requiring a certain amount of manipulation space to be able to unlock the connection, for example, by manual pressing on the front of the lock in order to separate the legs from the latter and to release the connection element from the base. This can prove impractical and make this operation difficult, especially when the connection element is not very accessible. In addition, in some of these devices, the lock does not necessarily remain attached to the connection element during unlocking, which can lead to its loss during the disconnection operation.

### BRIEF SUMMARY

One object of the present disclosure is to provide a connection device which differs from the state of the art. More precisely, one object of the present disclosure is to provide a device that is simple to unlock, and in a smaller working space than that necessary for unlocking the connection devices of the state of the art.

In order to achieve this aim, the object of the present disclosure is to propose a connection device between at least one pipe and a base having a tubular segment on which a collar is mounted, the connection device comprising a connection end piece intended for fluidly connecting the pipe to the base and a retaining ring intended to keep the connection end piece attached to the base:
the connection end piece comprising:
   a tubular body, of which a first end is intended to be inserted into the tubular segment of the base along a main axis, and of which a second end is intended to connect to the pipe;
   at least one first retaining element;
the retaining ring comprising:
   an annular body provided with a second retaining element that engages with the first retaining element to retain the retaining ring on the connection end piece; and
   at least one locking tab that is rigidly connected to the annular body and extends along the main axis for gripping the collar and keeping the retaining ring attached to the base.

According to other advantageous and non-limiting features of the present disclosure, taken alone or in any technically feasible combination:
the connection end piece comprises two first retaining elements arranged opposite each other and the retaining ring comprises two second retaining elements;
the second retaining elements and the locking tabs are angularly spaced at 90°;
the retaining ring comprises keying recesses for orienting the connection end piece relative to the retaining ring during their assembly, and ensuring the alignment of the first retaining element and of the second retaining element;
the first retaining element is flexible and the second retaining element is rigid;
the first retaining element is a flexible arm connected to the tubular body on the side of its first end and extending along the tubular body, the flexible arm comprising on an outer surface a lug cooperating with the second retaining element;
the second retaining element is a shoulder formed on an internal surface of the annular body;
the first retaining element is rigid and the second retaining element is flexible;
the second retaining element is a flexible arm formed on the retaining ring, the flexible arm comprising, on an internal surface, a lug that engages with the first retaining element;
the first retaining element is a shoulder formed on an external surface of the tubular body;
the connection device also comprises an immobilizing part intended to be inserted between the tubular body and the flexible arm;
the immobilizing part has the shape of a U-shaped staple comprising:
   an immobilizing leg intended to be inserted between the flexible arm and the tubular body; and
   a retaining leg provided with a lug to clip onto the flexible arm;
the immobilizing part comprises a pressure leg that is formed in the extension of the attachment leg and that is intended to unclip, by means of pressure, the attachment leg of the flexible arm;
the retaining ring is fitted with an extension comprising:
   a first end for connecting the extension to the retaining ring, the first end comprising a first retaining element identical to that of the connection end piece; and
   a second end for connecting the extension to the connection end piece, the second end comprising a second retaining element identical to that of the retaining ring;
the connection device also comprises a movable visual indicator of proper assembly arranged between the retaining ring and the connection end piece, the visual indicator of proper assembly being capable of sliding axially and/or radially when it comes into contact with the collar to make visible a portion of the visual indicator of proper assembly when the connection device is correctly attached to the base;
the visual indicator of proper assembly is a ring provided with two vertical uprights which extend axially along the main axis and each comprise a free end capable of being exposed through a slot formed in the retaining ring.

### BRIEF DESCRIPTION OF THE DRAWINGS

Other features and advantages of the present disclosure will become apparent from the following detailed description of example embodiments of the disclosure, which is provided with reference to the appended drawings, in which:

FIGS. 1A through 1D show the different stages of the implementation of a connection device according to the present disclosure;

FIG. 2 shows a three-way base to which three connection devices according to the present disclosure are connected;

FIGS. 3A and 3B show an immobilizing part for a connection device according to the present disclosure, respectively alone and attached to the device;

FIGS. 4A and 4B respectively show a sectional view of a connection device attached to a base along the plane (y, z) intersecting the locking tabs of the retaining ring, and along the plane (x, z) intersecting the flexible arms of the connection end piece;

FIG. 5 is an exploded view of a connection device provided with a visual indicator according to the present disclosure; and

FIG. 6 is an exploded view of a connection device according to an alternative embodiment of the present disclosure.

### DETAILED DESCRIPTION

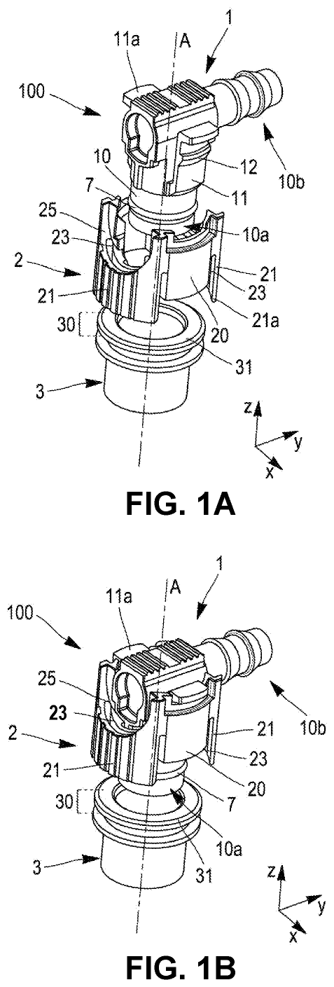

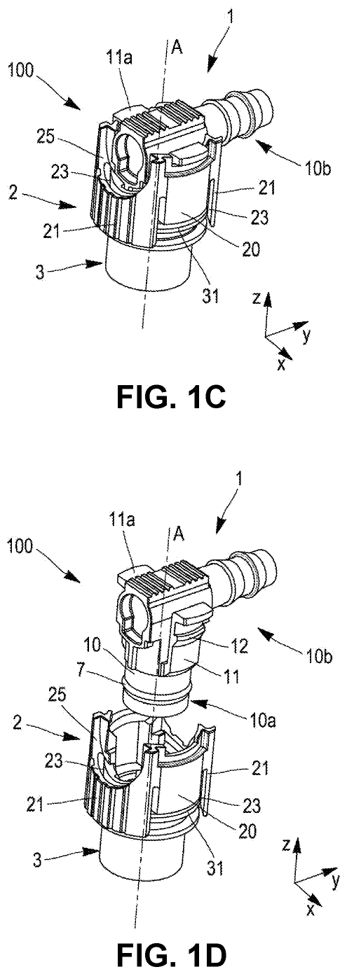

FIG. 1A shows an exploded overview of a connection device 100 according to the present disclosure.

The purpose of the connection device 100 is to connect a pipe (not shown in the figures) to a base 3 having a tubular segment 30 topped by a collar 31. The connection device 100 comprises a connection end piece 1 and a retaining ring 2. The connection end piece 1 is intended for fluidically connecting the pipe to the base 3, and the retaining ring 2 is in turn intended to keep the connection end piece 1 attached to the base 3. The connection configuration is of the female type on the base 3 side and of the male type on the connection end piece 1 side.

Advantageously, the connection end piece 1 and the retaining ring 2 are formed from a plastic material such as PA6.6 GF30 (a mixture of nylon and fiberglass).

### Description of the Connection Device

The connection end piece 1 comprises a tubular body 10 having a first end 10a and a second end 10b. The first end 10a is intended to be inserted, along a main axis A, in the tubular segment 30 of the base 3 (FIG. 1B). The second end 10b is intended to connect to the pipe and can be of the “fir tree connection” or “olive” type.

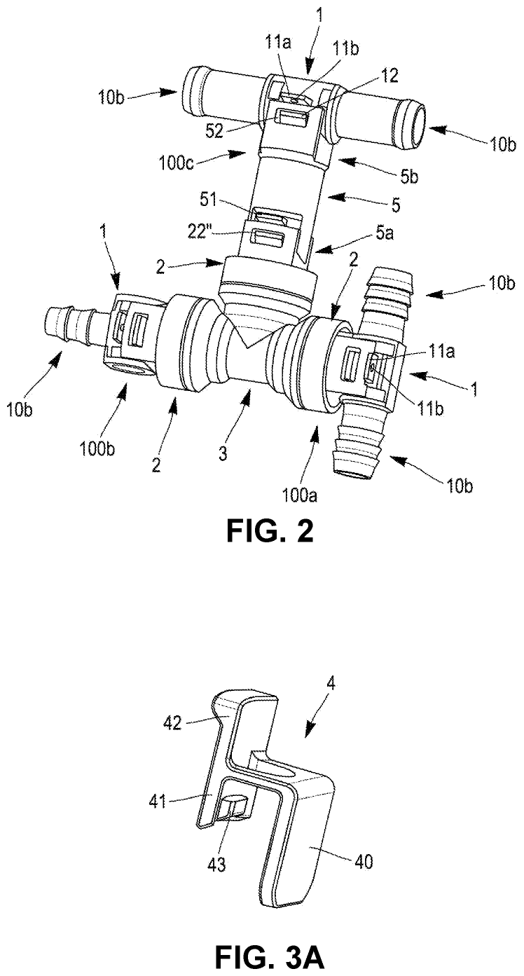

The connection end piece 1 can have different geometries, in particular an angled shape, like the connection devices 100 of FIGS. 1A to 1D, or straight like the connection device 100b of FIG. 2, or else in a “T” or double bend like the connection devices 100a, 100c of FIG. 2. The connection end piece 1 can also comprise a plurality of second ends 10b, according to the connection needs, to form a multi-way connector, as can be seen in FIG. 2.

The tubular body 10 is also provided, on its first end 10a, with a groove for accommodating a seal 7 in order to seal the connection with the base 3. Optionally, the tubular body 10 can also be provided, on its first end 10a, with a second groove to accommodate a second seal in order to form a double seal.

In order to keep the connection end piece 1 attached to the retaining ring 2, and also to allow it to be detached, the connection end piece 1 comprises at least one first retaining element 11, 11′. In the advantageous example illustrated in particular in FIGS. 1A to 1D, the connection end piece 1 comprises two first retaining elements 11, here two flexible arms 11, arranged opposite each other, on either side of the tubular body 10. These flexible arms 11 are connected to the tubular body 10, on the side of its first end 10a, and extend along the tubular body 10, in the direction opposite the first end 10a. The flexible arms 11 comprise, on their external surface, a lug 12 that is configured to cooperate with the retaining ring 2 so as to keep it attached to the connection end piece 1. These flexible arms 11 are advantageous in that they limit the forces for introducing the connection end piece 1 into the ring 2, thus facilitating their connection.

Advantageously, the free end 11a of the flexible arms 11 is bent outward to facilitate their manipulation.

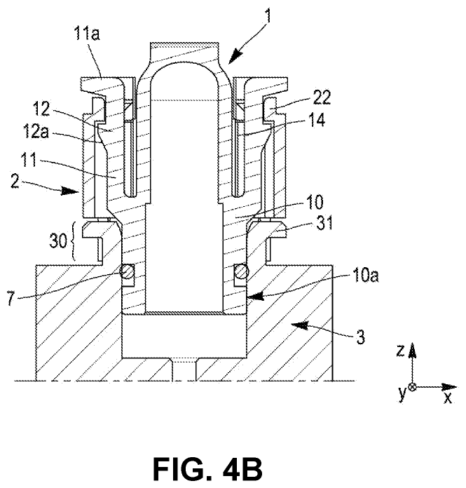

The flexible arms 11 can be brought closer to the tubular body 10, owing to the free space 14 between the tubular body 10 and the flexible arms 11 (FIG. 4B), to disengage the lug 12 from the retaining ring 2 and thus to disconnect the connection end piece 1. This configuration provides an easy solution for disconnecting the connection end piece 1 from the retaining ring 2, without increasing the bulk of the connection device 100, since the flexible arms 11 (or first retaining elements 11) do not have to move away from the tubular body 10, but rather must approach it in order to achieve the disconnection.

Advantageously, the lug 12 comprises an inclined plane 12a to facilitate the insertion of the connection end piece 1 into the retaining ring 2. Optionally, the free end 11a can be provided with an opening 11b (FIG. 2) to accommodate, for example, the ends of an angled clamp to facilitate the bringing together of the flexible arms 11.

The retaining ring 2 comprises an annular body 20 and at least one flexible locking tab 21. In the advantageous example illustrated in particular in FIGS. 1A to 1D, the retaining ring 2 comprises two flexible locking tabs 21 arranged facing one another, on either side of the annular body 20.

The retaining ring 2 extends generally around the tubular body 10 of the connection end piece 1 and around the collar 31 of the base 3, substantially defining the overall volume of the connection interface of the connection device 100 on the base 3.

The two locking tabs 21 are rigidly connected to the annular body 20 and extend along the main axis A for gripping the collar 31 and keeping the retaining ring 2 attached to the base 3. There is a free space 23 (FIG. 4A) between the locking tabs 21 and the annular body 20 that allows the locking tabs 21 to deform when the retaining ring 2 is inserted on the base 3 in order to limit the bulk of the device, without losing the guidance and retention of the connection end piece 1 on the retaining ring 2. In the example shown in the figures, the free end 21a of each locking tab 21 is provided, on its internal surface, with a locking lug 26 to cooperate with the collar 31. The locking lug 26 advantageously has an inclined plane 26′ to facilitate the clipping of the retaining ring 2 on the base 3.

The annular body 20 comprises at least one second retaining element 22, 22′; advantageously, it comprises two second retaining elements 22 to cooperate with the first retaining elements 11 of the connection end piece 1, and to secure the retaining ring 2 on the connection end piece 1 (FIG. 4B). The second retaining elements 22 are angularly spaced by 90° with respect to the locking tabs 21. This particular angular positioning makes it possible to reinforce the holding power between the retaining ring 2 and the base 3. Indeed, when a force is applied to axially pull out the retaining ring 2, by a liquid circulating in the pipe, for example, this force, through opposing movement, causes the locking tabs 21 to be brought together on the base 3 and the first retaining elements 11 to be separated. This bringing together improves the grip of the retaining ring 2 on the base 3, and therefore its holding power. The separation of the flexible arms 11 with respect to the tubular body 10 further strengthens their grip with the second retaining elements 22, and therefore the mechanical strength between the connection end piece 1 and the retaining ring 2.

In the example illustrated in particular in FIGS. 1A to 1D, the second retaining elements 22 are shoulders formed on the internal surface of the retaining ring 2, but other configurations could be imagined. Optionally, the annular body 20 may comprise a cavity or slot 22″ to accommodate the lug 12 of the flexible arms 11 when the retaining ring 2 is attached to the connection end piece 1, as can be seen in FIG. 2.

In the connection device 100 according to the present disclosure, the connections between the connection end piece 1 and the retaining ring 2, and between the retaining ring 2 and the base 3, are made in interior spaces of the retaining ring 2. The disconnection between the connection end piece 1 and the ring 2 (fixed to the base 3) can be carried out without increasing the overall bulk of the connection device 100, the overall bulk at the connection interface being substantially defined by the outer contours of the retaining ring 2. The disconnection between the retaining ring 2 and the base 3 can be done without significantly increasing the bulk, by moving the locking tab(s) 21 outward.

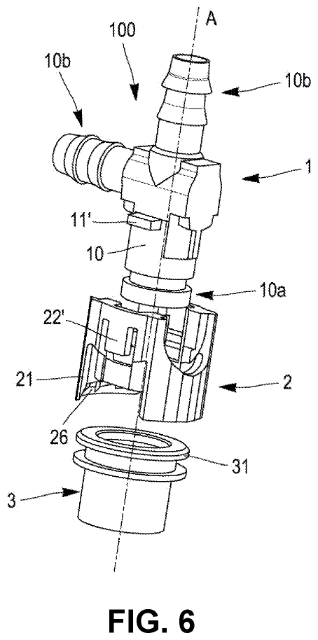

In the examples illustrated by FIGS. 1A to 5, the first retaining elements 11 are flexible and the second retaining elements 22 are rigid. It is of course possible, according to an alternative embodiment of the present disclosure illustrated in FIG. 6, to perform the reverse, namely first rigid retaining elements 11′ and second flexible retaining elements 22′. For example, as can be seen in FIG. 6, the first retaining elements 11′ can be a shoulder 11′ formed on the external surface of the connection end piece 1, and the second retaining elements 22′ of the flexible arms 22′, comprising a lug on their internal surface, formed on the retaining ring 2.

In the remainder of the description, only the embodiment of FIGS. 1A to 5 will be considered, the description being able to be easily adapted to the aforementioned alternative embodiment.

Advantageously, the retaining ring 2 comprises keying recesses 25 for orienting the connection end piece 1 relative to the retaining ring 2 during their assembly, and ensuring the alignment of the first retaining elements 11 and of the second retaining elements 22.

Optionally, the connection device 100 can also comprise an immobilizing part 4 intended to be inserted between the tubular body 10 and the flexible arm 11 to fill the free space 14 and block the approach of the flexible arms 11. This immobilizing part 4 is used in particular to prevent the accidental disconnections that are likely to occur during assembly via impacts, or during use due to extremely severe vibration profiles in confined spaces. In fact, depending on the intensity of the frequencies of the vibrations, relative movements between the elements of the connection device 100 may take place. This phenomenon, combined with the circulation of a fluid in the connection device 100, can present risks of disconnection. It may thus be desirable, in this particular case of extreme conditions, to secure the holding of the flexible arms 11 on the retaining ring 2.

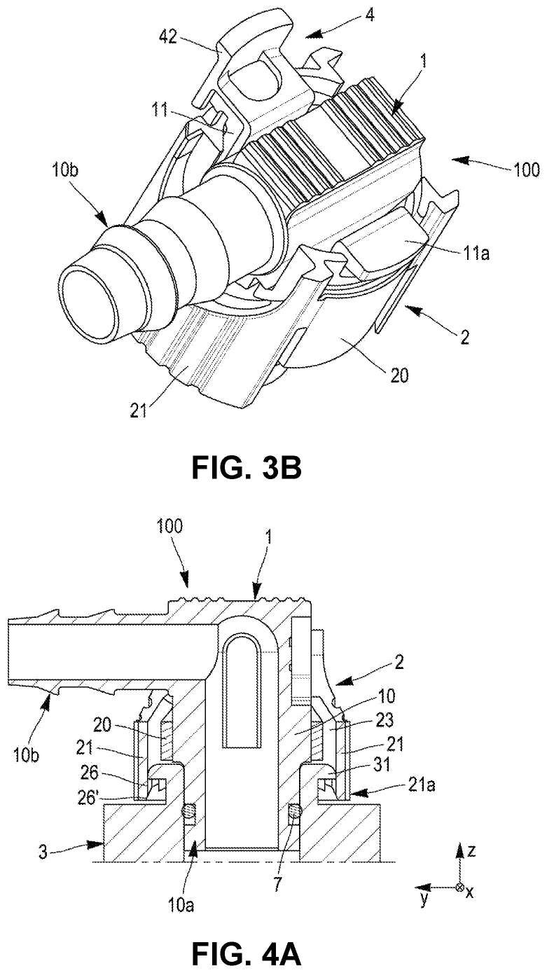

FIGS. 3A and 3B illustrate an immobilizing part 4, respectively alone and attached to the connection device 100.

The immobilizing part 4 has the shape of a U-shaped staple comprising an immobilizing leg 40, an attachment leg 41 and a pressure leg 42, formed in the extension of the attachment leg 41. The immobilizing leg 40 is intended to be inserted between the flexible arm 11 and the tubular body 10 to fill the free space 14. The attachment leg 41 is provided on its internal face with an attachment lug 43 to clip onto the free end 11a of the flexible arm 11. The attachment lug 43 can of course be clipped onto another part of the flexible arm 11, such as an opening or cavity formed for this purpose, or even clipped onto the retaining ring 2. The pressure leg 42 is intended to unclip, by means of pressure, the attachment leg 41 from the flexible arm 11.

Immobilizing a single flexible arm 11 is sufficient to prevent the connection end piece 1 from being removed from the retaining ring 2. However, provision can be made to use two immobilizing parts 4 to immobilize the two flexible arms 11, or to use an immobilizing part 4 having a geometry allowing the simultaneous immobilization of the two flexible arms 11.

Furthermore, and still optionally, the retaining ring 2 can be provided with an extension 5. This extension 5 acts as an intermediary between the retaining ring 2 and the connection end piece 1, as can be seen on the connection device 100c of FIG. 2, to relocate the junction between the connection end piece 1 and the retaining ring 2; such a configuration makes it possible in particular to take account of bulk and/or accessibility constraints. The extension 5 has a first end and a second end 5a, 5b. The first end 5a makes it possible to connect the extension 5 to the retaining ring 2 and comprises, similarly to the connection end piece 1, first retaining elements, here flexible arms 51. These flexible arms 51 have the same properties and operate in the same way as the flexible arms 11 of the connection end piece 1. The second end 5b makes it possible to connect the extension 5 to the connection end piece 1 and comprises, similarly to the retaining ring 2, second retaining elements 52. These second retaining elements 52 have the same properties and function in the same way as those of the retaining ring 2.

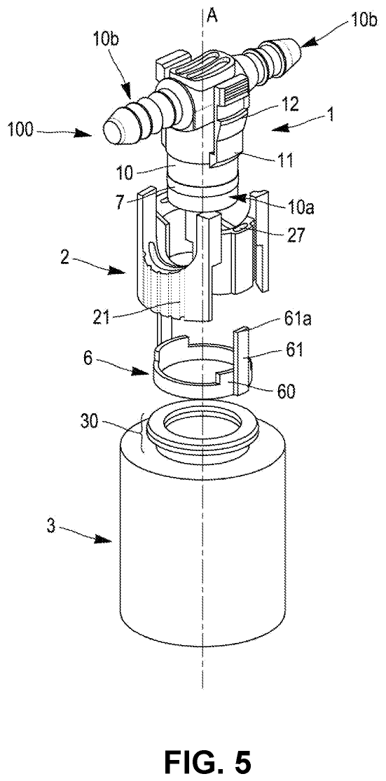

Advantageously, the connection device 100 can be provided with a visual indicator of proper assembly 6 (FIG. 5).

The visual indicator of proper assembly 6 is a movable part arranged between the retaining ring 2 and the connection end piece 1, a part 61a of which becomes visible, here through slots 27 formed on the retaining ring 2, when the connection device 100 is correctly attached on the base 3. It may be a ring 60 provided with two vertical uprights 61 which extend axially along the main axis A and each comprise a free end 61a, as shown in FIG. 5.

### Implementation of the Connection Device

A pre-assembly step is necessary before the connection device 100 can be used. This step makes it possible to attach, and to maintain attached, the retaining ring 2 to the connection end piece 1 so as to form the connection device 100 (FIGS. 1A, 1B).

The connection end piece 1 is previously oriented with respect to the retaining ring 2 in order to make the second end(s) 10b of the connection end piece 1 coincide with the keying recesses 25 of the retaining ring 2. This particular orientation makes it possible to align the second retaining elements 22 of the retaining ring 2 with the lugs 12 of the connection end piece 1.

Pressure is then exerted on the connection end piece 1 to assemble it to the retaining ring 2. When the connection end piece 1 is inserted through the retaining ring 2, the inclined plane 12a of the lugs 12 of the flexible arms 11 comes into contact against the retaining ring 2 and guides the approach of the flexible arms 11 against the tubular body 10. This approach allows the lugs 12 to pass into the retaining ring 2 so that they can be clipped onto the second retaining elements 22 of the retaining ring 2.

At the end of this pre-assembly step, the connection device 100 is in the state illustrated in FIG. 1B, and the retaining ring 2 is kept attached to the connection end piece 1.

According to a variant of the present disclosure, an extension 5 can be attached during this step between the retaining ring 2 and the connection end piece 1. The first end 10a of the connection end piece 1 is inserted through the second end 5b of the extension 5, aligning the second retaining elements 52 of the extension 5 with the lugs 12 of the connection end piece 1, to keep the connection end piece 1 attached to the extension 5. The first end 5a of the extension 5 is then inserted into the retaining ring 2. The flexible arms 51 of the extension 5 deform, then clip to the retaining ring 2, similarly to the flexible arms 11 of the connection end piece 1. At the end of this variant, the connection device 100 is found in the state illustrated by the connection device 100c of FIG. 2.

Optionally, after the pre-assembly step, an immobilizing part 4 can be inserted on one of the flexible arms 11, 51 to immobilize its movement and prevent the detachment of the connection device 100 (FIG. 3B). The immobilizing leg 40 is inserted between the flexible arm 11 and the tubular body 10, to fill the free space 14; the attachment lug 43 of the attachment leg 41 clips onto the free end 11a of the flexible arm 11, to keep the immobilizing part 4 attached to the flexible arm 11.

Once the pre-assembly step has been carried out, the connection device 100 is then fitted into the tubular segment 30 of the base 3, during an attachment step (FIG. 1C).

The first end 10a of the connection end piece 1 is inserted into the base 3 until the locking tabs 21 of the retaining ring 2 come into contact against the collar 31. The inclined plane 26′ of the locking lugs 26 comes into contact against the collar 31 and guides the radial separation of the locking tabs 21 until the locking lugs 26 are clipped onto the collar 31, which secures the retaining ring 2 to the base 3.

At the end of this assembly step, the connection device 100 is in the state illustrated by FIGS. 4A, 4B and 1C, and the connection device 100 is kept attached to the base 3.

According to another variant, the connection device 100 comprises a visual indicator of proper assembly 6. The visual indicator of proper assembly 6 is advantageously kept attached to the retaining ring 2, for example, owing to the locking tabs 21, the ring 60 resting on the locking lugs 26. During the insertion of the connection device 100, the collar 31 of the base 3 comes into contact against the ring 60 of the visual indicator of proper assembly 6. This contact causes axial and/or radial sliding of the visual indicator of proper assembly 6, within the connection device 100, until it occupies a final position when the connection device 100 is correctly connected to the base 3. In this final position, the free end 61a of the vertical uprights 61 of the visual indicator of proper assembly 6 is flush with the upper surface of the retaining ring 2, for example through a slot 27, and thus gives a visual indication of proper assembly.

Once the connection device 100 has been attached to the base 3, it remains possible to disconnect the connection end piece 1 from the base 3. To do this, it is necessary to remove the immobilizing part 4 beforehand, if it is present, by exerting pressure manually or by means of a tool, on the pressure leg 42, so as to cause the separation of the attachment leg 41 and to remove the attachment lug 43 from the free end 11a of the flexible arm 11. It is then possible to exert pressure on the free end 11a of the flexible arm 11, manually or via various tools, in order to bring the flexible arms 11 radially closer to one another. This approach makes it possible to remove the lugs 12 from the second retaining elements or shoulders. Since the connection end piece 1 is then no longer clipped to the retaining ring 2, it is possible to remove it while leaving the retaining ring 2 attached to the base 3 (FIG. 1D). It is thus possible to easily disconnect the connection end piece 1 and/or to interchange the connection end pieces 1, without removing the retaining ring 2.

During this disconnection, it is important to note that the volume of the connection device 100 does not increase, since the deformation necessary to perform the disconnection occurs within the volume already occupied by the connection device 100. The disconnection is possible without affecting the compactness of the connection device, which is an important advantage, in particular when the connection device 100 is placed in a confined space.

In addition, the disconnection is carried out by interacting with the upper part of the connection device 100, through the free ends 11a of the flexible arms 11, which makes it possible to facilitate unlocking, the free ends 11a being easily accessible and handling requiring a reduced workspace.

It is also possible, following the removal of the connection end piece 1 from the retaining ring 2, to disconnect the retaining ring 2 from the base 3. A tool can be inserted into the free space 23 to exert pressure on the locking tab 21 in order to remove the locking lugs 26 from the collar 31, which allows the retaining ring 2 to be removed. This disconnection can also be carried out manually, by moving the free end of the locking tabs 21 away or by putting pressure on the upper part of the locking tabs 21, close to the keying elements 25, to remove the locking lugs 26 from the collar 31 by tilting.

Of course, the invention is not limited to the embodiments described and it is possible to add variants without departing from the scope of the invention as defined by the claims.

Although a connection end piece comprising two first retaining elements has been illustrated, it would of course be possible to envisage a different number of these elements, for example between one and four, by adapting the number of second retaining elements accordingly.

Finally, although here we have given as an example and described a configuration where the retaining ring is provided with two locking tabs, it is of course possible to imagine configurations with a single locking tab, or a greater number of tabs, such as three tabs.

1. A connection device for connecting at least one pipe and a base having a tubular segment and a collar on the tubular segment, the connection device comprising a connection end piece for fluidly connecting the pipe to the base and a retaining ring for keeping the connection end piece attached to the base:
the connection end piece comprising:
a tubular body, of which a first end is configured to be inserted into the tubular segment of the base along a main axis, and of which a second end is configured to connect to the pipe;
two first retaining elements arranged opposite one another;
the retaining ring comprising:
an annular body provided with two second retaining elements that engage with the first retaining elements to retain the retaining ring on the connection end piece; and
two locking tabs rigidly connected to the annular body and extending along the main axis for gripping the collar and keeping the retaining ring attached to the base, the second retaining elements and the locking tabs being angularly spaced from one another by 90°.

2. The connection device of claim 1, wherein the retaining ring comprises keying recesses for orienting the connection end piece relative to the retaining ring during their assembly, and ensuring alignment of the two first retaining elements and of the two second retaining elements.

3. The connection device of claim 2, wherein each first retaining element is flexible and each second retaining element is rigid.

4. The connection device of claim 3, wherein each first retaining element is a flexible arm that is connected to the tubular body at the first end thereof and extends along the tubular body, the flexible arm comprising, on an outer surface, a lug that engages with each second retaining element.

5. The connection device of claim 4, wherein the second retaining element is a shoulder formed on an internal surface of the annular body.

6. The connection device of claim 2, wherein each first retaining element is rigid and each second retaining element is flexible.

7. The connection device of claim 6, wherein each second retaining element is a flexible arm formed on the retaining ring, the flexible arm, on an internal surface, a lug that engages with the first retaining element.

8. The connection device of claim 7, wherein each first retaining element is a shoulder formed on an external surface of the tubular body.

9. The connection device of claim 4, also further comprising an immobilizing part configured to be inserted between the tubular body and the flexible arm.

10. The connection device of claim 9, wherein the immobilizing part is in the shape of a U-shaped staple comprising:
an immobilizing leg intended to be inserted between the flexible arm and the tubular body; and
an attachment leg provided with an attachment lug for clipping onto the flexible arm.

11. The connection device of claim 10, wherein the immobilizing part comprises a pressure leg that is formed in an extension of the attachment leg and intended to unclip, by means of pressure, the attachment leg from the flexible arm.

12. The connection device of claim 1, wherein the retaining ring is provided with an extension comprising:
a first end for coupling the extension to the retaining ring, the first end comprising a first retaining element identical to that of the connection end piece; and
a second end for coupling the extension to the connection end piece, the second end comprising a second retaining element identical to that of the retaining ring.

13. The connection device of claim 1, further comprising a movable visual indicator of proper assembly arranged between the retaining ring and the connection end piece, the movable visual indicator of proper assembly being capable of sliding axially and/or radially when it comes into contact with the collar to make visible a portion of the movable visual indicator of proper assembly when the connection device is correctly attached to the base.

14. The connection device of claim 13, wherein the movable visual indicator of proper assembly is a ring provided with two vertical uprights that extend axially along the main axis and each comprise a free end capable of being exposed through a slot formed in the retaining ring.

15. The connection device of claim 1, wherein each first retaining element is flexible and each second retaining element is rigid.

16. The connection device of claim 15, wherein each first retaining element is a flexible arm that is connected to the tubular body at the first end thereof and extends along the tubular body, the flexible arm comprising, on an outer surface, a lug that engages with each second retaining element.

17. The connection device of claim 15, wherein the second retaining element is a shoulder formed on an internal surface of the annular body.

18. The connection device of claim 1, wherein each first retaining element is rigid and each second retaining element is flexible.

19. The connection device of claim 18, wherein each second retaining element is a flexible arm formed on the retaining ring, the flexible arm comprising, on an internal surface, a lug that engages with the first retaining element.

20. The connection device of claim 18, wherein each first retaining element is a shoulder formed on an external surface of the tubular body.
